(19) United States
(12) Patent Application Publication
(10) Pub. No.: US 2004/0265651 A1
(43) Pub. Date: Dec. 30, 2004

(54) Combined-Cycle Energy, Carbon and Hydrogen Production Process

(76) Inventor: Meyer Steinberg, Melville, NY (US)

Correspondence Address: LOUIS VENTRE, JR, 2483 OAKTON HILLS DRIVE, OAKTON, VA, 22124-1530, US

(21) Appl. No.: 10/604,153

(22) Filed: Jun. 27, 2003

(51) Int. Cl. H01M 8/00

(52) U.S. Cl. 429/13

(57) ABSTRACT

A method for producing energy, carbon and hydrogen from fossil or biomass fuel with minimal carbon dioxide emissions, such method combining the use of an Electric Arc Hydrogen Plasma Black Reactor, a Molten Carbonate Direct Carbon Fuel Cell, a Solid Oxide Fuel Cell, a Water Gas Shift Reactor, and a Steam Boiler Rankine Cycle.

### BACKGROUND OF INVENTION

An object of the invention is a highly efficient process for producing energy in the form of electricity and steam from carbonaceous fuels. A further object is to produce carbon from carbonaceous fuels. A further object is the production of hydrogen gas from carbonaceous fuels. Carbonaceous fuels are fossil fuels, such as natural gas, oil, coal, and biomass.

A further object of the invention is a process that will produce energy, carbon and hydrogen with low or zero carbon dioxide emissions.

A further object of the invention is to produce hydrogen in support of a United States” goal to reduce American reliance on foreign oil through a balance of new domestic energy production and new technology to promote greater energy efficiency. Producing hydrogen for these purposes is consistent with the United States Department of Energy's FreedomCAR program, which is a joint government and private sector research effort on advanced, efficient fuel cell technology which uses hydrogen to power automobiles without creating any pollution.

However, producing hydrogen from existing technologies often involves processes that generate more pollution than would have been produced by direct utilization of the fuels used to create the hydrogen.

Thus, achieving these objects will have significant benefits to the environment and the communities producing electricity and promoting utilization of hydrogen as an alternative clean burning fuel.

The subject invention is for a low emission, advanced combined cycle for fossil- and biomass-fueled power generation, for hydrogen production, and for carbon production to achieve these objects. In the method of the invention, five technologies, known in the art, are combined in a single integrated process. The combination is unique and in one case the means for integrating two of the technologies is new. The five technologies include an Electric Arc Hydrogen Plasma Black Reactor, a Molten Carbonate Direct Carbon Fuel Cell, a Water Gas Shift Reactor, a Solid Oxide Fuel Cell, and a Steam Boiler Rankine Cycle. In addition, the concept of combining an Electric Arc Hydrogen Plasma Black Reactor with a Direct Carbon Fuel Cell with a molten salt cycling integrating the two technologies is new.

The Direct Carbon Fuel Cell has been described in literature and is under development at the United States Department of Energy at its Lawrence Livermore National Laboratory. The Electric Arc Hydrogen Plasma Black Reactor was in commercial use in Canada producing carbon black. The Water Gas Shift Reactor and the Steam Boiler Rankine Cycle are well known and have been in commercial use for decades. The Solid Oxide Fuel Cell is well known and in commercial use.

### SUMMARY OF INVENTION

A method for producing energy, principally electrical energy, carbon and hydrogen from fossil or biomass fuel with minimal carbon dioxide emissions, such method combining the use of an Electric Arc Hydrogen Plasma Black Reactor, a molten carbonate Direct Carbon Fuel Cell, a Water Gas Shift Reactor, a Solid Oxide Fuel Cell, and a Steam Boiler Rankine Cycle.

These and other objects will be apparent to those having ordinary skill in the art. The method of the invention describes an advanced combined cycle for fossil and biomass fueled power generation, carbon and hydrogen production.

In the method of the invention, an Electric Arc Hydrogen Plasma Black Reactor decomposes a carbonaceous fuel (natural gas, oil, coal and biomass) to elemental carbon, hydrogen, carbon monoxide, ash and sulfur. The elemental carbon is used in commerce and is fed to a molten carbonate Direct Carbon Fuel Cell, which in turn produces electrical power and hot off gases. The hydrogen and carbon monoxide is used for recycle and in a Water Gas Shift Reactor to produce hydrogen, carbon monoxide and carbon dioxide. The hot off gases are used to generate energy in the form of steam and electricity in a Steam Boiler Rankine Cycle.

Carbon dioxide emissions from the Water Gas Shift Reactor, the Solid Oxide Fuel Cell and the Steam Boiler Rankine Cycle are used in commerce, that is some combination of selling it, sequestering it from the environment or discharging it as a waste. Carbon dioxide emissions are significantly reduced due to an increase in overall efficiency of power production of about two times that achievable with conventional power plants. Since the carbon dioxide from the Direct Carbon Fuel Cell and the Water Gas Shift Reactor is highly concentrated, the carbon dioxide can be sequestered to reduce emission towards zero with much less energy loss than required by conventional power plants.

Carbon dioxide sequestration is commercially practiced at a North Sea gas production station where it is pumped under the North Sea. Other sequestration methodologies have been proposed, such as pumping into depleted gas and oil wells.

The combined-cycle plant produces hydrogen for use off-site, for example in the transportation sector, in combination with electrical power production at total thermal efficiencies much greater than obtained with fossil fuel reforming and gasification plants producing hydrogen alone.

### BRIEF DESCRIPTION OF DRAWINGS

FIG. 1 illustrates the embodiment of the invention described in the detailed description. The boxes are intended to represent equipment essential to the process with labeled arrows showing primary inputs and outputs.

### DETAILED DESCRIPTION

The method of the invention describes a combined-cycle power, hydrogen and carbon production plant using carbonaceous fuels as feedstock. As used herein, carbonaceous fuels are natural gas, oil, coal and biomass; and, fossil fuels are natural gas, oil, and coal. The combined cycle plant is highly efficient with a potential for very low carbon dioxide emissions.

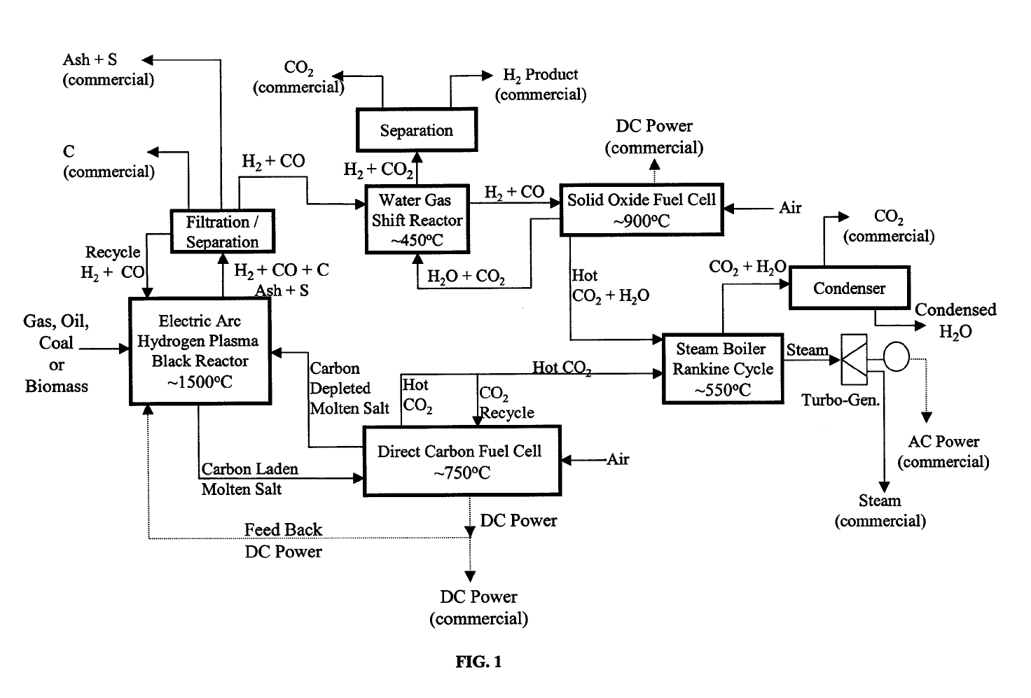

The combined cycle plant produces energy products, principally electrical energy and steam, carbon and hydrogen from fossil or biomass fuels. As shown in FIG. 1, the method claims the integrated use of an Electric Arc Hydrogen Plasma Black Reactor, a molten carbonate Direct Carbon Fuel Cell, a Water Gas Shift Reactor, a Solid Oxide Fuel Cell and a Steam Boiler Rankine Cycle plant. Correspondingly, there are five steps, steps (a) thru (e), in the claimed method of the invention.

In the method of the invention, there is a first step for using an Electric Arc Hydrogen Plasma Black Reactor wherein hydrogen, carbon monoxide, carbon, ash and sulfur are produced and used and wherein said Reactor consumes a carbonaceous fuel. Use of an Electric Arc Hydrogen Plasma Black Reactor, well known in the art, consumes carbonaceous fuel by creating hydrogen plasma in a continuous cracking process.

The useful effluent solid and gases from the Electric Arc Hydrogen Plasma Black Reactor are carbon, hydrogen, carbon monoxide and carbon dioxide. As used herein, only useful outputs from the process steps are noted. Nonuseful outputs from all of the process steps, such as gaseous compounds of nitrogen and sulfur, are well known in the art and are not noted herein, except to observe that they would be discharged in the usual fashion as wastes in a form compliant with environmental regulations.

As shown in FIG. 1, the Electric Arc Hydrogen Plasma Black Reactor is powered by electricity obtained from the operation of a Direct Carbon Fuel Cell. An alternate power supply is required to initiate startup of the system. Temperatures of the order of 1500 degrees centigrade are achieved in the hydrogen plasma between carbon electrodes where one or more carbonaceous fuels are introduced. At the process temperature, natural gas and oil fuels are cracked to carbon and hydrogen in one pass. For coal and biomass fuels, oxygen present in these fuels combines with some of the carbon to primarily produce carbon monoxide.

Carbon, produced in elemental form in the hydrogen plasma, is both entrained as particulates in the off gases and captured from the hydrogen plasma in a molten salt.

Part of the hydrogen stream containing the entrained carbon particulates in the off-gases are collected through filtering and are used in commerce, that is, sold for other uses.

As shown in FIG. 1, a molten salt serves as a working fluid and carbon transfer medium in both the Electric Arc Hydrogen Plasma Black Reactor and the Direct Carbon Fuel Cell. The molten salt is a molten carbonate salt of lithium and potassium.

The molten carbonate salt is circulated in a section below the carbon arc electrodes in the Electric Arc Hydrogen Plasma Black Reactor. The molten carbonate salt is in direct contact with the hydrogen plasma in an entrained fashion to scrub the carbon particulates out of hydrogen stream. The carbon thus becomes dispersed in the molten carbonate, creating a carbon laden molten salt. Carbon is also separated from the molten salt as is needed for its commercial use. The remaining carbon in the molten salt is sent to Direct Carbon Fuel Cell for consumption in another step of the process.

Ash, and sulfur as hydrogen sulfide gas, are emitted from the Electric Arc Hydrogen Plasma Black Reactor and are either captured in the molten carbonate salt or remain in the hydrogen off gas stream. These products have commercial value in addition to being disposable wastes.

As shown in FIG. 1, the ash and sulfur are separated from the other effluents by means well known in the art, that is, typically by solids density difference in the effluent and by scrubbing the effluent hydrogen stream.

The process efficiency of the Electric Arc Hydrogen Plasma Black Reactor varies with the carbonaceous fuel used and is in the range of 50 percent to 60 percent.

In the method of the invention, there is a second step, which is a step for using a Direct Carbon Fuel Cell wherein carbon from step (a) is consumed and wherein electricity and hot carbon dioxide gas are produced and used.

Direct Carbon Fuel Cell equipment and process are known in the art. As shown in FIG. 1, the primary function of the Direct Carbon Fuel Cell in the subject invention is to consume carbon derived from the first step to produce electricity and hot carbon dioxide gas.

Electricity produced from the Direct Carbon Fuel Cell is direct current electrical energy. Using the electricity firstly involves recycling some of the electricity to the Electric Arc Hydrogen Plasma Black Reactor to power the hydrogen plasma. This also involves converting direct current to alternating current electricity as may be required by the Electric Arc Hydrogen Plasma Black Reactor. Using the electricity secondly involves selling power in the commercial market, that is, it is either sold directly or converted to alternating current as required by the market.

In using the Direct Carbon Fuel Cell, the particulate carbon is removed from the carbon laden molten salt feedstock and converted to hot carbon dioxide, which emerges as an effluent from the anode compartment of the Direct Carbon Fuel Cell at 100 percent concentration. The carbon depleted molten salt is then re-circulated to the Electric Arc Hydrogen Plasma Black Reactor.

Air is consumed in the cathode compartment of the Direct Carbon Fuel Cell to provide oxygen for the process. The nonuseful gases remaining in the air after the oxygen is consumed are vented as waste. Heat generated in the Direct Carbon Fuel Cell is resident in the hot carbon dioxide gas effluent. Typically, the Direct Carbon Fuel Cell operates at temperatures about 700 to 800 degrees centigrade. Using said hot carbon dioxide gas first involves sending it to a Steam Boiler Rankine Cycle. Using said hot carbon dioxide gas secondly involves returning it to the cathode compartment of the Direct Carbon Fuel Cell. In the cathode compartment, the returned or recycled carbon dioxide is used to form carbonate ions in the molten carbonate, which in turn is used for transferring oxygen thru the molten carbonate salt electrolyte to react with the carbon in the anode compartment to form carbon dioxide.

The Direct Carbon Fuel Cell can operate at up to 90% efficiency producing electricity. Carbon dioxide from the Direct Carbon Fuel Cell is highly concentrated and can be directly used, that is, sequestered or sold for other uses.

In the method of the invention, there is a third step, which is a step for using a Water Gas Shift Reactor wherein the hydrogen, and carbon monoxide produced in step (a) is used and wherein water and carbon dioxide gases from step (d) are used and wherein hydrogen, carbon monoxide and carbon dioxide are produced and used.

The Water Gas Shift Reactor is well known in the art. In the method of the invention, the Water Gas Shift Reactor consumes said carbon monoxide and hydrogen to output hydrogen and carbon monoxide and carbon dioxide gases. Using the hydrogen, carbon dioxide and carbon monoxide gases requires the input of water and carbon dioxide, which is provided by a Solid Oxide Fuel Cell from a subsequent step of the process. The Water Gas Shift Reactor typically operates below 500 degrees centigrade.

As shown in FIG. 1, some of the output hydrogen gas and carbon monoxide gas are used by sending them to a Solid Oxide Fuel Cell as a feedstock for electric power production.

The remainder of the output hydrogen gas and carbon dioxide gas are used firstly by separating the gases by means well known in the art into a concentrated stream of carbon dioxide gas and a concentrated stream of hydrogen gas. Carbon dioxide is separated from the hydrogen to purify a hydrogen gas product. This is typically accomplished by pressure swing adsorption, separating with a membrane or scrubbing with a solvent. The carbon dioxide is then used in commerce, that is some combination of selling it, sequestering it from the environment or discharging it as a waste. The hydrogen gas is then sold for other commercial uses. The amount of hydrogen gas sent to the Solid Oxide Fuel Cell and the amount concentrated into a stream and subsequently sold is determined by trading off the need for consuming the hydrogen for efficient electrical power production in the Solid Oxide Fuel Cell and the highest economic return from selling the hydrogen.

Secondly, the carbon dioxide is used in commerce, that is some combination of selling it, sequestering it from the environment or discharging it as a waste. Sequestering it is by means well known in the art, which reduces or eliminates carbon dioxide emission to the atmosphere.

In the method of the invention, there is a fourth step, which is a step for using a Solid Oxide Fuel Cell wherein hydrogen and carbon monoxide from step (c) are consumed and wherein electricity is produced and used and wherein carbon dioxide gas and water are produced and used.

Using a Solid Oxide Fuel Cell involves consuming hydrogen and carbon monoxide from step (c) and producing electric energy, carbon dioxide gas and water.

In the Solid Oxide Fuel Cell, which is well known in the art, oxygen ions are transmitted through a ceramic membrane, which oxidizes the carbon monoxide and hydrogen gas to carbon dioxide and water and produces direct current electric energy. Using the Solid Oxide Fuel Cell involves sending some of the carbon dioxide and water to the Water Gas Shift Reactor. Using it further involves sending hot carbon dioxide and water to a Steam Boiler Rankine Cycle. Finally, using it involves selling power in the commercial market, that is, the produced electricity is either sold directly or converted to alternating current as required by the market.

The Solid Oxide Fuel Cell typically operates at about 900 degrees centigrade and is about 56 percent thermally efficient.

Finally, a fifth step is a step for using a Steam Boiler Rankine Cycle wherein the hot carbon dioxide gas produced in the Direct Carbon Fuel Cell of step (b) is used, wherein the water and carbon dioxide gas produced in the Solid Oxide Fuel Cell of step (d) is used and wherein steam is produced and used.

Using a Steam Boiler Rankine Cycle involves extracting the heat from the hot carbon dioxide and water inputs to make steam. The Steam Boiler Rankine Cycle typically operates at about 550 degrees centigrade and about 60 atmospheres pressure. This process is well known in the art. Using a Steam Boiler Rankine Cycle further involves outputting carbon dioxide, water, steam and electricity. In such use, the concentrated carbon dioxide is used in commerce, that is some combination of selling it, sequestering it from the environment or discharging it as a waste. Sequestration is accomplished by means well known in the art, to reduce or eliminate its emission to the atmosphere. The steam is subsequently used by directly selling it in commerce and by producing electricity for sale in commerce. A Steam Boiler Rankine Cycle is well known in the art and is about 38 percent thermally efficiency.

In the method of the invention, carbon dioxide is sequestered from concentrated streams of carbon dioxide gas. An important benefit of the process is that sequestering concentrated carbon dioxide uses much less energy than would be required for a dilute mixture from conventional power and hydrogen production plants.

The calculated thermal efficiency for electricity production alone of the combined steps of the process ranges above 70 percent to exceeding 80 percent based on the Higher Heating Value of the carbonaceous fuel. Carbonaceous fuels are typically defined in terms of energy content, that is, Higher Heating Value and Lower Heating Value. This calculated efficiency range is about twice that typically obtained from conventional Steam Boiler Rankine Cycle power plants. Consequently, the quantity of carbon dioxide produced in the combined cycles of the process will be about half that from conventional steam and gasification plants and are in such concentrations as to facilitate the operations to use it, that is sequestering it or selling it in the commercial market, at a minimum cost.

For combined electricity and hydrogen production, the using the method of the invention provides a thermal efficiency exceeding 90 percent based on the Higher Heating Value of the carbonaceous fuel. Consequently, the quantity of carbon dioxide produced in the combined cycles of the process will be about half that from conventional steam and gasification plants and are in such concentrations as to facilitate the operations to use it, that is sequestering it or selling it in the commercial market, at a minimum cost.

While there has been described herein what is considered to be the preferred exemplary embodiment of the present invention, other modifications of the present invention shall be apparent to those skilled in the art from the teachings herein, and it is therefore, desired to be secured in the appended claim all such modifications as fall the true spirit and scope of the invention.

Accordingly, what is desired to be secured by Letters Patent of the United States the invention as defined and differentiated in the following claim in which I claim:

1. A method for the production of energy, carbon and hydrogen in a combined cycle, the method comprising the steps for
(a) using an Electric Arc Hydrogen Plasma Black Reactor wherein hydrogen, carbon monoxide, carbon, ash and sulfur are produced and used and wherein said Reactor consumes a carbonaceous fuel;
(b) using a Direct Carbon Fuel Cell wherein carbon from step (a) is consumed and wherein electricity and hot carbon dioxide gas are produced and used;
(c) using a Water Gas Shift Reactor wherein the hydrogen, and carbon monoxide produced in step (a) is used and wherein water and carbon dioxide gases from step (d) are used and wherein hydrogen, carbon monoxide and carbon dioxide are produced and used;
(d) using a Solid Oxide Fuel Cell wherein hydrogen and carbon monoxide from step (c) are consumed and wherein electricity is produced and used and wherein carbon dioxide gas and water are produced and used;
(e) using a Steam Boiler Rankine Cycle wherein the hot carbon dioxide gas produced in the Direct Carbon Fuel cell of step (b) is used, wherein the water and carbon dioxide gas produced in the Solid Oxide Fuel Cell of step (d) is used and wherein steam is produced and used.
